(19) United States
(12) Patent Application Publication
(10) Pub. No.: US 2024/0290197 A1
(43) Pub. Date: Aug. 29, 2024

(54) SYNCHRONIZATION OF ALARM NOTIFICATIONS ACROSS MULTIPLE HUB DEVICES

(71) Applicant: Ademco Inc., Golden Valley, MN (US)

(72) Inventors: Nagaraj Chickmagalur LAKSHMINARAYAN, Bangalore, Karnataka (IN); Kenneth ESKILDSEN, Great Neck, NY (US); Sachin Prakash MAGANTI, Bangalore, Karnataka (IN)

(21) Appl. No.: 18/692,407

(22) PCT Filed: Oct. 3, 2022
(86) PCT No.: PCT/US2022/045521

§ 371 Date: Mar. 15, 2024

Related U.S. Application Data
(60) Provisional application No. 63/253,238, filed on Oct. 7, 2021.

(51) Int. Cl. G08B 27/00; H04W 72/044

(52) U.S. Cl. CPC G08B 27/003; H04W 72/044

(57) ABSTRACT

Techniques for synchronizing superframes across apparatuses are disclosed. An apparatus for communication with a plurality of devices is set to a premise communication mode. While in the premise communication mode, the apparatus outputs a first superframe configured in a premise communication superframe mode allocating each slot of a plurality of slots for wireless communication to a first protocol at a first frequency band or a different second protocol. The apparatus transitions from the premise communication mode to a community communication mode. While in the community communication mode, the apparatus outputs a second superframe configured in a community communication superframe mode allocating at least one slot for wireless communication to the first protocol or the second protocol at the first frequency band, and at least one slot for wireless communication to a community beacon including data relating to a unique key recognizable by a remote apparatus.

### RELATED APPLICATION

This application claims priority to U.S. Provisional Application No. 63/253,238 filed Oct. 7, 2021, the entire contents of which are incorporated herein by reference.

### TECHNICAL FIELD

The disclosure relates to networks, for instance, networks used in home automation, comfort, and security systems.

### BACKGROUND

A home network may use a wireless network protocol to connect devices within the home. For example, a hub device may use IEEE 802.15.4 to connect to over one hundred sensor devices in a home to the hub device. The hub device may then collect sensor data collected by the sensor devices in the home. For instance, the hub device may collect door/window, or other security or home automation, sensor readings and output the door/window, or other security or home automation, sensor readings to a home security sensor or other device in the home network or, in some cases, to a remote server. In another instance, the hub device may collect temperature readings from multiple temperature sensors arranged within the home and output the temperature readings to a thermostat that controls an HVAC system using the temperature readings.

### SUMMARY

In general, this disclosure relates to systems, devices, and methods for wirelessly connecting hub devices that act as their own central processing station for different local sets of devices. These hub devices communicate amongst one another by inserting particular data blocks into a “slot” of a repeating “superframe.” While these slots may have a particular order and structure when the hub device is only attempting to communicate amongst the local sensor devices in the respective hub device's network (e.g., by being in a “premise” communication mode), under certain circumstances, a hub device may alter one of the slots in the repeating superframe (e.g., when in a “community” communication mode) such that another hub device that receives the superframe over a broadcast can detect that an alarm event affecting the community has been detected.

Techniques described herein may improve a performance of a network. For example, a hub device that performs dynamic mode shifting between a premise communication mode and a community communication mode may more efficiently communicate alarm events to nearby devices that could also be affected by the alarm event. This can result since the superframe is already being broadcast at regular intervals by the initial hub device, and simply altering one of the slots within that superframe means that the network is not polluted by extraneous data packets that would exist if the hub device instead broadcast a special message indicating the alarm event in addition to the already broadcasted superframes.

Furthermore, this shifting of communication modes for a superframe can help maintain privacy by the original device. When in the premise communication mode, while the other hub devices nearby the user's hub device may detect the broadcasted superframes, the nearby hub devices may refrain from processing those superframes to maintain the user's privacy. When altered through the slot change while in the community superframe mode, the nearby hub devices can process only that slot to determine whether the alarm event affects the nearby hub device.

Continuing from the above example, in some instances a single radio chip can be utilized to carry out the community communication superframe mode and the premise communication superframe mode, in addition to different frequency bands. As a result, a single superframe including both a slot at the first frequency band and another slot at the second, different frequency band can allow a sensor device that has the ability to wirelessly communicate, via different radios, at both the first and second frequency bands to switch between these frequency bands to communicate with the hub device using a single identification (e.g., a single PAN ID). Moreover, the ability to dynamically introduce the second, different frequency band slot in the single superframe having the first frequency band slot and shift the time location of the second, different frequency band slot within the single superframe can allow for the optimization of bandwidth allocation within the single superframe and, thereby, can reduce traffic, and resulting jamming, on the first frequency band.

One embodiment includes an apparatus for communication with a plurality of devices. The apparatus comprising processing circuitry configured to set the apparatus to a premise communication mode. The processing circuitry is further configured to while the apparatus is in the premise communication mode, output, to the plurality of devices, a first superframe configured in a premise communication superframe mode, the premise communication superframe mode allocating each slot of a plurality of slots for wireless communication to a first protocol at a first frequency band or a second protocol at the first frequency band, wherein the first protocol and the second protocol are different from each other. The processing circuitry is also configured to transition the apparatus from the premise communication mode to a community communication mode. The processing circuitry is further configured to, while the apparatus is in the community communication mode, output, to the plurality of devices, a second superframe configured in a community communication superframe mode, the community communication superframe mode allocating: i) at least one slot of a plurality of slots for wireless communication to the first protocol at the first frequency band or the second protocol at the first frequency band, and ii) at least one slot of the plurality of slots for wireless communication to a community beacon, the community beacon including data relating to a unique key recognizable by a remote apparatus.

In a further embodiment of the apparatus, the processing circuitry is configured to transition the apparatus from the premise communication mode to the community communication mode in response to the processing circuitry receiving a community communication mode command.

In one such example of this further embodiment of the apparatus, the processing circuitry is further configured to receive a dangerous event alarm notification with the community communication mode command.

In another such example of this further embodiment of the apparatus, the community communication mode command comprises a dangerous event alarm notification. The processing circuitry is further configured to evaluate the dangerous event alarm notification to determine an alarm type. The processing circuitry is also configured to determine, based at least in part on the alarm type, whether a nearby premises that houses the remote apparatus is in danger. The processing circuitry is further configured to, in response to determining that the nearby premises that houses the remote apparatus is in danger, transition the apparatus from the premise communication mode to the community communication mode.

In a further embodiment this example of the apparatus, the processing circuitry is further configured to determine whether to transition the apparatus from the premise communication mode to the community communication mode based on one or more of one or more settings of the apparatus, one or more characteristics of a premises that houses the apparatus, and one or more characteristics of the nearby premises that houses the remote apparatus.

In another example of the further embodiment of the apparatus, the dangerous event alarm notification comprises one or more of a fire alarm notification, a carbon monoxide alarm notification, a panic alarm notification, a break-in alarm notification, or a critical alarm notification.

In a further embodiment of the apparatus, the community beacon is configured to cause the remote apparatus to output an alarm indication when the remote apparatus receives the community beacon.

In a further embodiment of the apparatus, the apparatus is configured for communication with the plurality of devices using time divisional multiple access (TDMA).

In a further embodiment of the apparatus, the processing circuitry is further configured to, prior to transitioning the apparatus from the premise communication mode to the community communication mode, receive an indication of user input enabling the community communication mode on the apparatus.

In one such example of this further embodiment of the apparatus, the processing circuitry is further configured to receive an indication of user input disabling the community communication mode on the apparatus. The processing circuitry is also configured to receive a second community communication mode command. The processing circuitry is further configured to output a third superframe configured in the premise communication superframe mode. The processing circuitry is also configured to refrain from outputting a fourth superframe configured in the community communication superframe mode.

Another embodiment includes a method. This method embodiment includes the step of setting, by one or more processors of an apparatus for communication with a plurality of devices, the apparatus to a premise communication mode. The method further includes the step of, while the apparatus is in the premise communication mode, outputting, by the one or more processors, and to the plurality of devices, a first superframe configured in a premise communication superframe mode, the premise communication superframe mode allocating each slot of a plurality of slots for wireless communication to a first protocol at a first frequency band or a second protocol at the first frequency band, wherein the first protocol and the second protocol are different from each other. The method also includes the step of transitioning, by the one or more processors, the apparatus from the premise communication mode to a community communication mode. The method further includes the step of, while the apparatus is in the community communication superframe mode, outputting, by the one or more processors, and to the plurality of devices, a second superframe configured in a community communication superframe mode, the community communication superframe mode allocating: i) at least one slot of a plurality of slots for wireless communication to the first protocol at the first frequency band or the second protocol at the first frequency band, and ii) at least one slot of the plurality of slots for wireless communication to a community beacon, the community beacon including data relating to a unique key recognizable by a remote apparatus.

In a further embodiment of the method, the step of transitioning the apparatus from the premise communication mode to the community communication mode comprises the step of transitioning, by the one or more processors, the apparatus from the premise communication mode to the community communication mode in response to the processing circuitry receiving a community communication mode command.

In one such example of the further embodiment of the method, method further includes the step of receiving, by the one or more processors, a dangerous event alarm notification with the community communication mode command.

In another such example of this further embodiment of the method, community communication mode command comprises a dangerous event alarm notification. The method further includes the step of evaluating, by the one or more processors, the dangerous event alarm notification to determine an alarm type. The method also includes the step of determining, by the one or more processors, based at least in part on the alarm type, whether a nearby premises that houses the remote apparatus is in danger. The method further includes the step of, in response to determining that the nearby premises that houses the remote apparatus is in danger, transitioning, by the one or more processors, the apparatus from the premise communication mode to the community communication mode.

In one such embodiment of this additional example of the method, the method further includes the step of determining, by the one or more processors, whether to transition the apparatus from the premise communication mode to the community communication mode based on one or more of one or more settings of the apparatus, one or more characteristics of a premises that houses the apparatus, and one or more characteristics of the nearby premises that houses the remote apparatus.

In another example of this further embodiment of the method, the dangerous event alarm notification comprises one or more of a fire alarm notification, a carbon monoxide alarm notification, a panic alarm notification, a break-in alarm notification, or a critical alarm notification.

In a further embodiment of the method, the method further comprises the step of, in response to the remote apparatus receiving the alarm indication, outputting, by one or more processors of the remote apparatus, an alarm indication.

In a further embodiment of the method, the apparatus is configured for communication with the plurality of devices using time divisional multiple access (TDMA).

In a further embodiment of the method, the method further comprises the step of, prior to transitioning the apparatus from the premise communication mode to the community communication mode, receiving, by the one or more processors, an indication of first user input enabling the community communication mode on the apparatus. The method also includes the step of receiving, by the one or more processors, an indication of second user input disabling the community communication mode on the apparatus. The method further includes the step of receiving, by the one or more processors, a second community communication mode command. The method also includes the step of outputting, by the one or more processors, a third superframe configured in the premise communication superframe mode. The method further includes the step of refraining, by the one or more processors, from outputting a fourth superframe configured in the community communication superframe mode.

An additional embodiment includes a system. This system embodiment includes a hub device comprising a first set of one or more processors. The system embodiment further includes a plurality of devices in communication with the hub device. The system embodiment also includes a remote hub device comprising a second set of one or more processors. The first set of one or more processors of the hub device are configured to set the hub device to a premise communication mode. The first set of one or more processors are further configured to, while the hub device is in the premise communication mode, output, to the plurality of devices, a first superframe configured in a premise communication superframe mode, the premise communication superframe mode allocating each slot of a plurality of slots for wireless communication to a first protocol at a first frequency band or a second protocol at the first frequency band, wherein the first protocol and the second protocol are different from each other. The first set of one or more processors are also configured to transition the hub device from the premise communication mode to a community communication mode. The first set of one or more processors are further configured to, while the hub device is in the community communication mode, output, to the plurality of devices, a second superframe configured in a community communication superframe mode, the community communication superframe mode allocating: i) at least one slot of a plurality of slots for wireless communication to the first protocol at the first frequency band or the second protocol at the first frequency band, and ii) at least one slot of the plurality of slots for wireless communication to a community beacon, the community beacon including data relating to a unique key recognizable by a remote hub device. The second set of one or more processors of the remote hub device are configured to, in response to receiving the community beacon, output an alarm condition. The second set of one or more processors are further configured to transition the remote hub device from the premise communication mode to the community superframe mode. The second set of one or more processors are also configured to, while the remote hub device is in the community communication mode, output a third superframe configured in the community communication superframe mode.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1A is a conceptual diagram illustrating devices in communication using a premise communication superframe mode, in accordance with some examples of this disclosure.

FIG. 1B is a conceptual diagram illustrating devices in communication using an updated superframe mode (e.g., a community communication superframe mode), in accordance with some examples of this disclosure.

FIG. 2A is a conceptual block diagram illustrating an example of a home network, in accordance with some examples of this disclosure.

FIG. 2B is a conceptual block diagram illustrating a hub device in greater detail, in accordance with some examples of this disclosure.

FIG. 3 is a conceptual block diagram of a hub device and a sensor device, in accordance with some examples of this disclosure.

FIG. 4 is a conceptual block diagram of a first example of slots of a single superframe in a premise communication superframe mode, in accordance with some examples of this disclosure.

FIGS. 5A-5D are conceptual block diagrams of different first example of slots of a single superframe, for instance in a community communication superframe mode, in accordance with some examples of this disclosure.

FIG. 6 is a conceptual diagram of a multiplex dwelling that includes multiple different homes in a same overall building, in accordance with some examples of this disclosure.

FIG. 7 is a flow diagram illustrating a method, in accordance with some examples of this disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Modern residential buildings or other buildings may include a central “hub” device configured to manage one or more systems within the building, such as monitoring systems, comfort systems, security systems, and/or home automation systems. The hub device can be in wireless communication with a number of other devices placed throughout the building. For example, the hub device may wirelessly receive sensor data from any number of different sensor devices, such as motion sensors, air quality and/or temperature sensors, infrared sensors, door and/or window contact sensors, switches, and/or other sensor devices. Additionally, the hub device may wirelessly transmit commands or instructions to one or more controllable sensor devices. For example, the hub device may instruct a thermostat to adjust a temperature within the building, or in another example, may command a damper to open or close an air vent.

In some applications for managing one or more systems within a building, BLUETOOTH radio communication techniques may have an advantage over other radio connection techniques such as, for example, IEEE 802.15.4 radio communication techniques. For instance, BLUETOOTH radio communications techniques may support high data rates and throughput compared to IEEE 802.15.4 radio communication techniques. For example, BLUETOOTH may have a bandwidth of greater than 500 kilobits-per-second (kbps) (e.g., 1 Mbps) and IEEE 802.15.4 may have a bandwidth of less than 500 kbps (e.g., 250 kbps). From a range perspective, BLUETOOTH radio techniques and IEEE 802.15.4 radio communication techniques may have nearly equal link budget. BLUETOOTH may have a range of greater than 80 meters (e.g., 100 meters) and IEEE 802.15.4 may have a range of less than 80 meters (e.g., 70 meters). In some examples, BLUETOOTH may have a join time (e.g., latency) of greater than 1 second (e.g., 3 seconds) and IEEE 802.15.4 may have a join time of less than 1 second (e.g., 30 milliseconds (ms)). BLUETOOTH may have a stack size of greater than 100 kb (e.g., 250 kb) and IEEE 802.15.4 may have a stack size of less than 100 kb (e.g., 28 ms). In some examples, IEEE 802.11, also referred to herein as simply “Wi-Fi™,” may offer even higher data rates than BLUETOOTH but with a higher energy cost.

As used herein, BLUETOOTH may refer to present and future versions of BLUETOOTH. Examples of BLUETOOTH include classic BLUETOOTH (e.g., Versions 1.0, 1.0B, 1.1, 1.2, 2.0, 2.1, 3.0, 4.0, 4.1, 4.2, 5, 5.1, etc.), BLUETOOTH-low energy (e.g., Versions 4.0, 4.1, 4.2, 5, 5.1, etc.), and other types of BLUETOOTH. As such, all instances of “BLUETOOTH” herein should be interpreted as including classic BLUETOOTH and/or BLUETOOTH-low energy. BLUETOOTH may operate at frequencies between 2.402 and 2.480 GHz, 2.400 and 2.4835 GHz including a 2 MHZ wide guard band and a 3.5 MHz wide guard band, or another frequency range. In some examples, each frequency channel of the BLUETOOTH channel may have a center frequency different from a central frequency of a neighboring channel by less than 1 MHz. In some examples, each frequency channel of a wireless channel (e.g., an IEEE 802.15.4 channel) may have a center frequency different from a central frequency of a neighboring channel by greater than 1 MHZ (e.g., 2 MHZ, 5 MHz, etc.).

In some cases, BLUETOOTH can refer to communications that use frequency hopping, such as, for example, frequency-hopping spread spectrum, to avoid interference from other radio communications. For example, a device using a BLUETOOTH channel may operate a BLUETOOTH channel that hops between 37 frequency channels when using advertising channels and 40 frequency channels when operating without advertising channels. In contrast, IEEE 802.15.4 may instead use a direct sequence spread spectrum technique. For example, a device may establish a wireless channel using IEEE 802.15.4 by mixing a signal for the wireless channel with a pseudo-random code which is then extracted by a receiver from an external device. Direct sequence spread spectrum may help to enhance the signal-to-noise ratio by spreading the transmitted signal across a wide band. In some examples, a device establishing a wireless channel using IEEE 802.15.4 may be configured to scan for a clear spectrum.

Smart home devices may deploy many different wireless protocols to address the needs to the smart home. There are standards based protocols (Wi-Fi™, Zigbee™, Thread™, Zwave™, BLUETOOTH, DECT™, etc.) and proprietary, manufacture specific protocols. The issue with this array of protocols is that each protocol is tuned to a specific application. For example, Wi-Fi™ may be particularly useful for high bandwidth data applications that do not require long battery life. Zigbee™ may be particularly useful for low bandwidth data applications to maximize battery life. Additionally, not every wireless protocol is globally compliant. For example, Zwave™ may have different hardware designs for various operational regions.

Smart home systems may include a collection of different networks that operate at a common frequency suitable for home networks. For example, a Wi-Fi™ network of a smart home system, a BLUETOOTH network of the smart home system, and an IEEE 802.15.4 network of the smart home system may each operate at a 2.4 GHz frequency. A hub device may allocate each device to a time slot, also referred to herein as simply “slot,” of the superframe during a registration process. For example, the hub device may allocate a Wi-Fi™ slot to one or more first devices, a BLUETOOTH slot to one or more second devices, and an IEEE 802.15.4 slot to one or more third devices. In this example, the hub device may output the superframe using a beacon that specifies a beginning of the superframe. All devices of the network may synchronize to the beacon and output data at the 2.4 GHz frequency according to the allocated slots of the superframe. For instance, the one or more first devices output data in accordance with the Wi-Fi™ protocol during the Wi-Fi™ slot, the one or more second devices output data in accordance with the BLUETOOTH protocol during the BLUETOOTH slot, and the one or more third devices output data in accordance with the IEEE 802.15.4 protocol during the 802.15.4 slot.

In accordance with the techniques of the disclosure, rather than using a fixed superframe mode, the hub device may dynamically adjust a superframe. In doing so, in addition to the communication between a hub device and the multiple sensor devices, the hub device may utilize the superframe to communicate with nearby hub devices controlling other premises. For example, the hub device may be configured to use an initial, premise superframe mode for communication with sensor devices in a general, ongoing basis. Moreover, the hub device can additionally dynamically adjust the superframe when the hub device transitions to a community communication mode, to adjust and/or introduce various slots, at various time locations, in the single superframe to better introduce communication with nearby hub devices. This could be due to alarm events happening at the premises monitored by the hub device, such as a fire or a carbon monoxide leak, where that alarm event could adversely affect the premises monitored by the nearby hub device. A hub device that dynamically adjusts a superframe mode may increase a bandwidth of the network compared to hub devices that use a fixed superframe mode with additional messages for communicating alarm events.

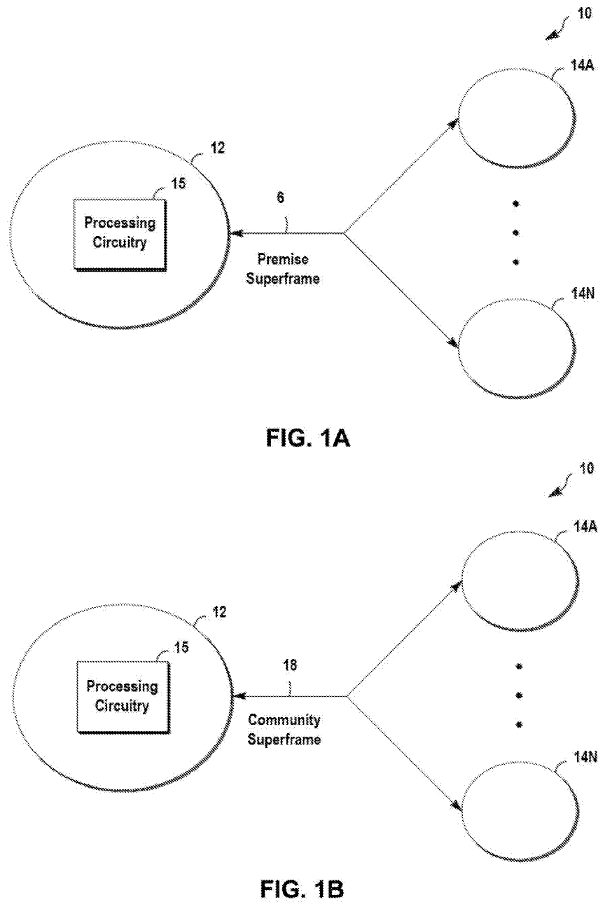

FIG. 1A is a conceptual diagram illustrating devices in communication using an initial superframe mode, in accordance with some examples of this disclosure. In some examples, the initial superframe mode is a time divisional multiple access (TDMA) superframe mode. While system 10 illustrates only hub device 12 and sensor devices 14A-14N (collectively, “sensor devices 14” or simply “devices 14”), system 10 may include additional devices (e.g., devices in wireless communication with each other) or fewer devices. System 10 may be installed within a building and the surrounding premises (collectively, “premise”).

Hub device 12 may include a computing device configured to operate one or more systems within a building, such as comfort, security, safety, and/or home automation systems. For example, as described further below, hub device 12 may include processing circuitry 15 configured to receive data, such as received from one or more devices and/or from user input, and process the data in order to automate one or more systems within a building. For example, hub device 12 may automate, control, or otherwise manage systems including heating and cooling, ventilation, illumination, or authorized access to individual rooms or other regions, as non-limiting examples. For example, hub device 12 may include a “Life and Property Safety Hub®” of Resideo Technologies, Inc.®, of Austin, Texas. Hub device 12 may include a wired connection to an electric power grid, but in some examples may include an internal power source, such as a battery, supercapacitor, or another internal power source.

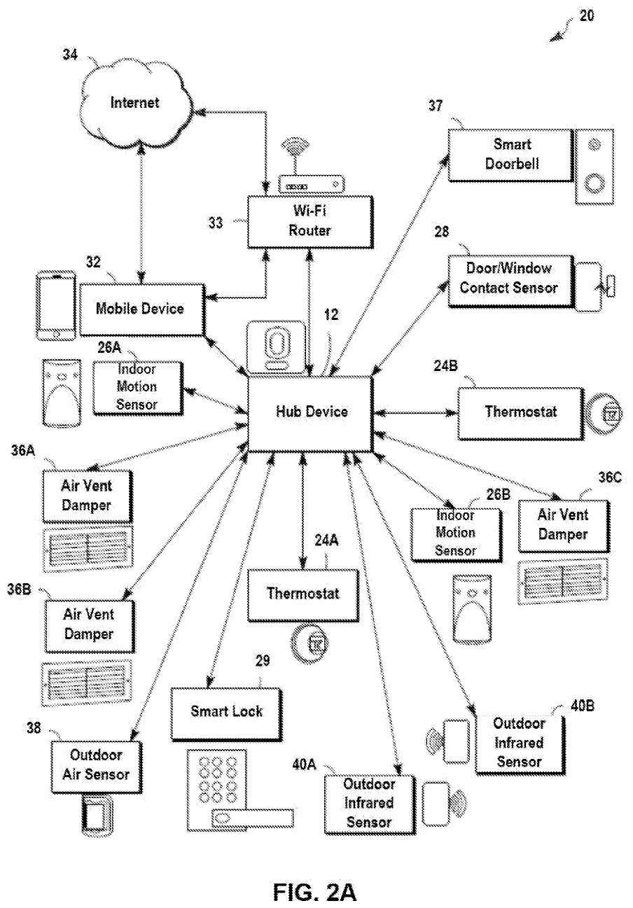

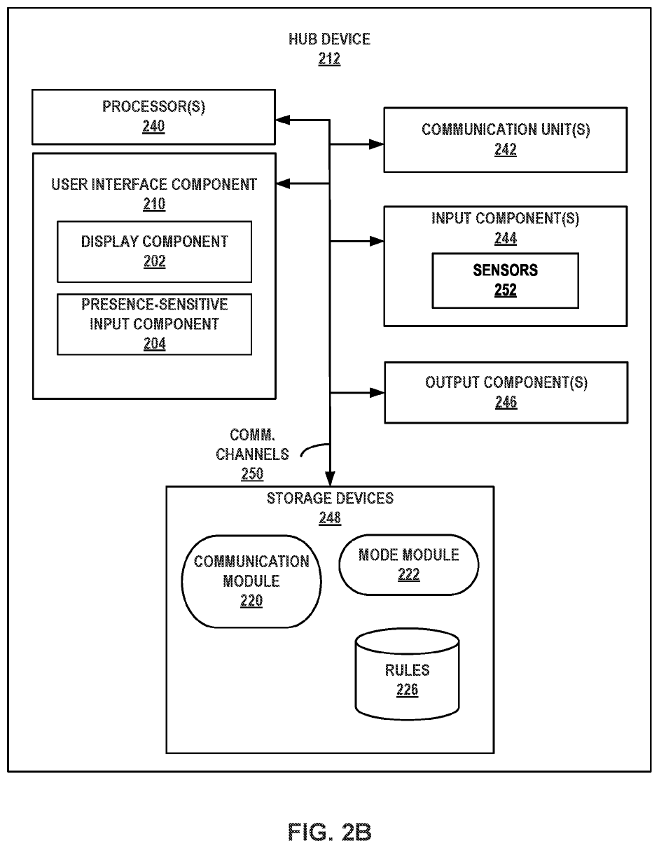

Sensor devices 14 may be configured to enroll with hub device 12. For example, sensor device 14 may be configured to exchange sensor data with hub device 12 and/or be controlled by hub device 12. Sensor devices 14 may be configured to collect or generate sensor data and transmit the sensor data to hub device 12 for processing. In some examples, sensor device 14 may include a controllable device. A controllable device may be configured to perform a specified function when the controllable device receives instructions (e.g., a command or other programming) to perform the function from hub device 12. Examples of different types of sensor devices 14 are included in the description of FIG. 2A. Sensor devices 14 may include either a wired connection to an electric power grid or an internal power source, such as a battery, supercapacitor, or another internal power source.

Processing circuitry 15 may be configured to communicate with sensor devices 14 using one or more wireless communication protocols and one or more frequency bands (e.g., two different frequency bands). Examples of wireless communication protocols may include, but not limited to, a low-power wireless connection protocol, a high-bandwidth connection protocol, or a local area networking protocol. Examples of a low-power connection protocol may include, but are not limited to, IEEE 802.15.4, a low power protocol using a 900 MHz frequency band, or another low-power connection protocol. As used herein, IEEE 802.15.4 may include any standard or specification compliant with IEEE 802.15.4, such, as for example, Zigbee™, ISA100.11a™, WirelessHART™, MiWi™, 6LOWPAN™, Thread™, SNAP™, and other standards or specifications that are compliant with IEEE 802.15.4. That is, for example, IEEE 802.15.4 should be interpreted herein as including implementations relying only on the IEEE 802.15.4 standard as well as implementations that build upon the IEEE 802.15.4 standard with additional specifications, such as, for example, Zigbee™. Examples of a high-bandwidth connection protocol may include, for example, BLUETOOTH (e.g., classic BLUETOOTH, BLUETOOTH low energy, etc.). Examples of a local area networking protocol may include, for example, Wi-Fi™ (e.g., IEEE 802.11 a/b/g/n/ac, etc.).

Although FIG. 1A shows hub device 12 as directly connected to sensor devices 14, in some examples, system 10 may include one or more repeater nodes that are each configured to act as an intermediary or “repeater” device. For example, sensor device 14A may output first data in accordance with Wi-Fi™ to a first repeater device, which outputs the first data to hub device 12. In this example, sensor device 14B may output second data in accordance with BLUETOOTH to a second repeater device, which outputs the second data to hub device 12. The first repeater device and the second repeater device may be the same device (e.g., a device configured to communicate in accordance with BLUETOOTH and in accordance with Wi-Fi™) or may be separate devices.

Processing circuitry 15 may be configured to use TDMA for communication in system 10. For example, a Wi-Fi™ network of a smart home system, a BLUETOOTH network of the smart home system, and an IEEE 802.15.4 network of the smart home system may operate at a 2.4 GHz frequency (e.g., within a band of frequencies comprising 2.4 GHz). In this example, processing circuitry 15 may register each of devices 14 to a slot of a superframe constructed in accordance with premise communication superframe mode. For example, processing circuitry 15 may allocate sensor device 14A to a first slot of a premise superframe 16, also referred to herein as simply “superframe 16,” for a group of devices and allocate sensor device 14N to a second slot of superframe 16 for a group of devices. Processing circuitry 15 may “output” superframe 16 by outputting a beacon signaling the beginning of the superframe. Each one of sensor devices 14 may synchronize with the beacon and output data according to the slots defined by the superframe. In some examples, processing circuitry 15 may periodically output superframe 16 to allow sensor devices 14 to output data.

Hub device 12 may allocate multiple devices to a single slot of a superframe, but possibly at different portions of the single slot. For example, hub device 12 may allocate sensor device 14A to a first 4 ms portion of an IEEE 802.15.4 slot and allocate sensor device 14N to a second 4 ms portion of the IEEE 802.15.4 slot that is different from the first 4 ms portion of the IEEE 802.15.4 slot. In some examples, hub device 12 may allocate sensor device 14A to a first channel (e.g., 2.402 GHZ) of a BLUETOOTH slot and allocate sensor device 14N to a second channel (e.g., 2.479 GHZ) of the BLUETOOTH slot that is different from the first channel.

Processing circuitry 15 may use multiple superframes and/or a single superframe with slots allocated to device communication at different frequency bands. For example, processing circuitry 15 may allocate sensor device 14A to a slot of a first superframe for a first group of devices and allocate sensor device 14N to a slot of a second superframe for a second group of devices. Processing circuitry 15 may output the first superframe by outputting a first beacon signaling the beginning of the first superframe. In response to the first beacon, sensor device 14A may output data according to the slots defined by the first superframe while sensor device 14N refrains from outputting data during the first superframe. In this example, processing output the second superframe by outputting a second beacon signaling the beginning of the second superframe. In response to the second superframe, sensor device 14A may refrain from outputting data and sensor device 14B may output data according to the slots defined by the second superframe. Processing circuitry 15 may periodically output the first superframe and the second superframe to allow sensor devices 14 to output data.

In some systems, a hub device may use a single superframe mode for each superframe. For example, the hub device may allocate time for Wi-Fi™ and IEEE 802.15.4 communication when a system has video data to communicate over BLUETOOTH. In this example, maintaining the time allocated to Wi-Fi™ and/or IEEE 802.15.4 may reduce a bandwidth of the network compared to systems that dynamically increase an amount of time for BLUETOOTH communication when a system has video data to communicate over BLUETOOTH.

Rather than using a single superframe mode, hub device 12 may be configured to use multiple superframe modes, each superframe mode allocating each slot of a plurality of slots for wireless communication to a first protocol, a second protocol, and/or a third protocol. In some examples, the first protocol, the second protocol, and the third protocol are different from each other. For example, the first protocol may include a local area networking protocol, the second protocol may include a low-power wireless connection protocol, and/or the third protocol may include a high-bandwidth connection protocol. For instance, the first protocol may include Wi-Fi™. In some examples, the second protocol may include IEEE 802.15.4. The third protocol may include BLUETOOTH.

For example, hub device 12 may be configured to use a comfort normal superframe mode that supports 64 devices with 4 ms alarm slots. In some examples, hub device 12 may be configured to use a comfort BLUETOOTH pairing superframe mode that allocates extra time (e.g., 40 ms) for BLUETOOTH pairing. In some examples, hub device 12 may be configured to use a mutually exclusive comfort BLUETOOTH pairing superframe mode that allocates extra time (e.g., 72 ms) for BLUETOOTH pairing. In some examples, hub device 12 may be configured to use a BLUETOOTH high bandwidth superframe mode that allocates extra time (e.g., 40 ms) for BLUETOOTH communications. In some examples, hub device 12 may be configured to use a Wi-Fi™ pairing superframe mode that allocates extra time (e.g., 101 ms) for Wi-Fi™ communications. In some examples, hub device 12 may be configured to use a security normal superframe mode that supports 128 devices with 2 ms alarm slots. In some examples, hub device 12 may be configured to use a security BLUETOOTH pairing superframe mode that allocates extra time for BLUETOOTH pairing. Hub device 12 may be configured to use any number of superframe modes (e.g., 6, more than 6, etc.). The foregoing examples of superframe modes are for example purposes only. For example, hub device 12 may additionally or alternatively use other superframe modes. For instance, the hub device 12 can use an initial super frame mode that allocates slots for device communication at only a first frequency band, and the hub device 12 can use a multi-frequency superframe mode that allocates slots for devices communication at each of the first frequency band and a second, different frequency band.

In accordance with the techniques of the disclosure, processing circuitry 15 may execute according to different communication modes when outputting superframe 16. For example, processing circuitry 15 may initially be set in a premise communication mode. While in the premise communication mode, processing circuitry may output a first superframe configured in a premise communication superframe mode. The premise communication superframe mode causes processing circuitry 15 to allocate each slot of a plurality of slots for wireless communication to a first protocol at a first frequency band or a second protocol at the first frequency band, wherein the first protocol and the second protocol are different from each other.

FIG. 1B is a conceptual diagram illustrating devices in communication using an updated superframe mode, in accordance with some examples of this disclosure. In examples within the scope of this disclosure, the updated superframe mode can be, for instance, a multi-frequency superframe mode. Processing circuitry 15 may receive a data packet, whether it be an alarm event or a community communication mode command, that causes processing circuitry 15 and/or a hub device 12 to shift from a premise communication mode to a community communication mode. For example, in response to receiving an alarm event from a flood sensor located on the premises of hub device 12, processing circuitry 15 may determine to change from the premise communication mode to the community communication mode. While in the community communication mode, processing circuitry 15 may output community superframe 18 configured in a community communication superframe mode. The community communication superframe mode causes processing circuitry 15 to allocate at least one slot of a plurality of slots for wireless communication to the first protocol at the first frequency band or the second protocol at the first frequency band. Processing circuitry 15 may also allocate at least one slot of the plurality of slots for wireless communication to a community beacon, the community beacon including data relating to a unique key recognizable by a remote apparatus. The community beacon may also provide an indication of the alarm event. For instance, if the remote apparatus is a hub device for an apartment directly beneath the apartment where hub device 12 is located, a flood alarm could be detrimental to the residents of the apartment holding the remote apparatus. As such, by transmitting the alarm event in this way using the community beacon, the apartment holding the remote hub device can be alerted to the detrimental condition without further polluting the airwaves of the network transmitting superframes in general.

FIG. 2A is a conceptual block diagram illustrating a networked system 20, which may be one example of the networked system 10 of FIG. 1, in accordance with some examples of this disclosure. System 20 includes hub device 12, thermostat 24A, thermostat 24B (collectively, thermostats 24), indoor motion sensor 26A, outdoor motion sensor 26B (collectively, motion sensors 26), door/window contact sensor 28, air vent damper 36A, 36B, 36C (collectively, air vent dampers 36), smart doorbell 37, outdoor air sensor 38, outdoor infrared sensor 40A, indoor infrared sensor 40B (collectively, infrared sensors 40), router 33, and mobile device 32. Hub device 12 and one or more of the devices in the networked system 20 can communicate using a first frequency band (e.g., 2.4 GHZ) and/or a second, different frequency band (e.g., sub 1 GHz). For example, at least one device in the networked system 20 can communicate with hub device 12 using the first frequency band while at least one other device in the networked system 20 can communicate with hub device 12 using the second, different frequency band. In another example, at least one device in the networked system 20 can selectively communication with hub device 12 using one of the first frequency band and the second, different frequency band as selected for a specific superframe. While hub device 12 is shown as a distinct component, hub device 12 may be integrated into one or more of thermostats 24, motion sensors 26, door/window contact sensor 28, air vent dampers 36, smart doorbell 37, outdoor air sensor 38, and infrared sensors 40. The various devices of system 20 are for example purposes only. For example, additional devices may be added to system 20 and/or one or more devices of system 20 may be omitted.

The system 20 is a non-limiting example of the techniques of this disclosure. Other example systems may include more, fewer, or different components and/or devices. While FIG. 2A illustrates a mobile phone, mobile device 32 may, in some examples, include a tablet computer, a laptop or personal computer, a smart watch, a wireless network-enabled key fob, an e-readers, or another mobile device. Mobile device 32 and/or router 33 may be connected to a wide area network, such as, for example, internet 34. Internet 34 may represent a connection to the Internet via any suitable interface, such as, for example, a digital subscriber line (DSL), dial-up access, cable internet access, fiber-optic access, wireless broadband access, hybrid access networks, or other interfaces. Examples of wireless broadband access may include, for example, satellite access, WiMax™, cellular (e.g., 1X, 2G, 3G™, 4G™, 5G™, etc.), or another wireless broadband access.

Central hub device 12 may be in wireless data communication with thermostats 24, motion sensors 26, door/window contact sensor 28, air vent dampers 36, smart doorbell 37, outdoor air sensor 38, and infrared sensors 40. For example, thermostats 24, motion sensors 26, door/window contact sensor 28, air vent dampers 36, smart doorbell 37, outdoor air sensor 38, and infrared sensors 40 may be directly connected to hub device 12 using one or more wireless channels according to a connection protocol, such as, but not limited to, for example, IEEE 802.15.4, BLUETOOTH, or another connection protocol.

Each of thermostats 24, motion sensors 26, door/window contact sensor 28, air vent dampers 36, smart doorbell 37, outdoor air sensor 38, and infrared sensors 40 may include either a sensor device (e.g., a device configured to collect and/or generate sensor data), a controllable device, or both, as described herein. For example, thermostats 24 may include comfort devices having sensors, such as a thermometer configured to measure an air temperature. In some examples, air vent dampers 36 may include devices located within an air vent or air duct, configured to either open or close the shutters of an air vent in response to receiving instructions from hub device 12.

Although not shown in the example of FIG. 2A, central hub device 12 may be in indirect wireless data communication (e.g., communication via a repeater node) with one or more of thermostats 24, motion sensors 26, door/window contact sensor 28, air vent dampers 36, smart doorbell 37, outdoor air sensor 38, and infrared sensors 40. For example, outdoor air sensor 38 may be indirectly connected thermostat to hub device 12 using a wireless channel according to a connection protocol, such as, but not limited to, for example, IEEE 802.15.4, BLUETOOTH, or another connection protocol. For instance, outdoor air sensor 38 may be connected to hub device 12 via thermostat 24A, outdoor infrared sensor 40A may be connected to hub device 12 via outdoor motion sensor 26B, etc.

Thermostats 24 may be configured to wirelessly transmit the temperature (e.g., sensor data) directly to hub device 12. Additionally, thermostats 24 may include controllable devices, in that they may activate or deactivate a heating, cooling, or ventilation system in response to receiving instructions from hub device 12. For example, thermostat 24A may collect temperature data and transmit the data to hub device 12. Hub device 12, in response to receiving the temperature data, may determine that a respective room is either too hot or too cold based on the temperature data, and transmit a command to thermostat 24A to activate a heating or cooling system as appropriate. In this example, each of thermostats 24 may include both sensor devices and controllable devices within a single distinct unit.

Indoor and outdoor motion sensors 26 may include security devices configured to detect the presence of a nearby mobile object based on detecting a signal, such as an electromagnetic signal, an acoustic signal, a magnetic signal, a vibration, or other signal. The detected signal may or may not be a reflection of a signal transmitted by the same device. In response to detecting the respective signal, motion sensors 26 may generate sensor data indicating the presence of an object, and wirelessly transmit the sensor data to hub device 12. Hub device 12 may be configured to perform an action in response to receiving the sensor data, such as outputting an alert, such as a notification to mobile device 32, or by outputting a command for the respective motion sensor 26 to output an audible or visual alert. In this example, each of motion sensors 26 may include both sensor devices and controllable devices within a single unit.

Door and/or window contact sensor 28 may include a security device configured to detect the opening of a door or window on which the door and/or window contact sensor 28 is installed. For example, contact sensor 28 may include a first component installed on a door or window, and a second component installed on a frame of the respective door or window. When the first component moves toward, past, or away from the second component, the contact sensor 28 may be configured to generate sensor data indicating the motion of the door or window, and wirelessly transmit the sensor data to hub device 12. In response to receiving the sensor data, hub device may be configured to perform an action such as outputting an alert, such as a notification to mobile device 32, or by outputting a command for the respective contact sensor 28 to output an audible or visual alert. In this example, contact sensor 28 may include a sensor devices and a controllable devices within a single unit.

Air vent dampers 36 may be configured to regulate a flow of air inside of a duct. For example, thermostats 24 may generate a control signal to close air vent damper 36A (e.g., when the room is not occupied). In this example, in response to the control signal, air vent damper 36 may close to prevent air from flowing from air vent damper 36A. In some examples, air vent dampers 36 may send sensor data indicating a state (e.g., open or closed) of the respective air vent damper. For instance, air vent damper 36 may output, to thermostats 24 an indication that air vent damper 36 is in an open state.

Smart doorbell 37 may be configured to provide notifications to hub device 12. For example, smart doorbell 37 may be configured to provide a notification (e.g., message) when a button (e.g., doorbell) of smart doorbell 37 is activated. In some examples, smart doorbell 37 may include motion sensor circuitry configured to generate a notification in response to motion detected near smart doorbell 37. In some examples, smart doorbell 37 may be configured to generate video content in response to motion detected near smart doorbell 37. In some examples, smart doorbell 37 may be configured to generate audio content in response to motion detected near smart doorbell 37. For instance, in response to motion detected near smart doorbell 37, smart doorbell 37 may generate video content using a camera and/or audio content using a microphone. In this instance, smart doorbell 37 may output the video content and audio content to hub device 12, which may forward the video content and/or audio content to mobile device 32.

Outdoor air sensor 38 may be configured to generate sensor data indicating, for example, a temperature, humidity, and/or quality (e.g., carbon monoxide, particulate matter, or other hazards) of the surrounding air. In some examples, outdoor air sensor 38 may wireless transmit the sensor data to hub device 12. For instance, outdoor air sensor 38 may periodically output a current or average temperature to thermostats 24 via hub device 12.

Outdoor passive infrared sensors 40 may include security devices configured to detect the presence of a nearby object, such as a person, based on detecting infrared wavelength electromagnetic waves emitted by the object. In response to detecting the infrared waves, passive infrared sensors 40 may generate sensor data indicating the presence of the object, and wirelessly transmit the sensor data to hub device 12. Hub device 12 may be configured to perform an action in response to receiving the sensor data, such as outputting an alert, such as a notification to mobile device 32, or by outputting a command for the respective passive infrared sensor 40 to output an audible or visual alert.

System 20 may include various devices, including, for example, a security device, a water heater, a water flow controller, a garage door controller, or other devices. For example, system 20 may include one or more of: a door contact sensor, a motion passive infrared (PIR) sensor, a mini contact sensor, a key fob, a smoke detector, a glass break detector, a siren, a combined smoke detector and Carbon monoxide (CO) detector, an indoor siren, a flood sensor, a shock sensor, an outdoor siren, a CO detector, a wearable medical pendant, a wearable panic device, an occupancy sensor, a keypad, and/or other devices.

In accordance with the techniques of the disclosure, hub device 12 and each of thermostats 24, motion sensors 26, door/window contact sensor 28, air vent dampers 36, smart doorbell 37, outdoor air sensor 38, and infrared sensors 40 may be configured to operate using a superframe. While various examples described herein use Wi-Fi™ as an example of a first protocol, IEEE 802.15.4 as an example second protocol, and BLUETOOTH as an example of third protocol, in some examples, other protocols may be used. Smart doorbell 37 is used as an example sensor device for example purposes only, and the other devices illustrated in FIG. 2 may operate in a similar, including identical, manner. In some examples, the first protocol, the second protocol, and the third protocol are different from each other. For example, the first protocol may include a local area networking protocol, the second protocol may include a low-power wireless connection protocol, and/or the third protocol may include a high-bandwidth connection protocol. For instance, the first protocol may include Wi-Fi™. In some examples, the second protocol may include IEEE 802.15.4. The third protocol may include BLUETOOTH.

Hub device 12 may be initially operating in premise communication mode. While hub device 12 is in the premise communication mode, hub device 12 may output, to each of thermostats 24, motion sensors 26, door/window contact sensor 28, air vent dampers 36, smart doorbell 37, outdoor air sensor 38, and infrared sensors 40, a first superframe configured in a premise communication superframe mode. The premise communication superframe mode means that hub device 12 may allocate each slot of a plurality of slots for wireless communication to a first protocol at a first frequency band or a second protocol at the first frequency band, wherein the first protocol and the second protocol are different from each other.

Hub device 12 may then receive a community communication mode command from door/window contact sensor 28. When in a secure mode, this command may indicate that an intruder is breaking into premises that holds hub device 12 and door/window contact sensor 28. Door/window contact sensor 28 may classify this as an alarm event, causing door/window contact sensor 28 to generate and send the command to hub device 12. When multiple premises are close to one another, an intruder in the premises holding hub device 12 could indicate danger to nearby premises.

As such, hub device 12 may transition from the premise communication mode to a community communication mode. While hub device 12 is in the community communication mode, hub device 12 may output, to each of thermostats 24, motion sensors 26, door/window contact sensor 28, air vent dampers 36, smart doorbell 37, outdoor air sensor 38, and infrared sensors 40, a second superframe configured in a community communication superframe mode. The community communication superframe mode means that hub device 12 allocates at least one slot of a plurality of slots for wireless communication to the first protocol at the first frequency band or the second protocol at the first frequency band. Hub device 12 also allocates at least one slot of the plurality of slots for wireless communication to a community beacon, the community beacon including data relating to a unique key recognizable by a remote apparatus. When the remote apparatus receives and recognizes this unique key, the remote apparatus may output an alarm event such that occupants of the premises holding the remote apparatus are aware that there is an intruder nearby, alerting them to the dangerous situation.

FIG. 2B is a block diagram illustrating an example hub device configured to transmit superframes in either a premise communication mode or a community communication mode, in accordance with one or more aspects of the techniques described in this disclosure. Hub device 212 of FIG. 2B is described below as an example of computing device 110 of FIG. 1. FIG. 2 illustrates only one particular example of hub device 212, and many other examples of hub device 212 may be used in other instances and may include a subset of the components included in example hub device 212 or may include additional components not shown in FIG. 2B.

Hub device 212 may be any computer with the processing power required to adequately execute the techniques described herein. For instance, hub device 212 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2B, hub device 212 includes user interface component (UIC) 210, one or more processors 240, one or more communication units 242, one or more input components 244, one or more output components 246, and one or more storage components 248. UIC 210 includes display component 202 and presence-sensitive input component 204. Storage components 248 of hub device 212 include communication module 220, mode module 222, and rules data store 226.

One or more processors 240 may implement functionality and/or execute instructions associated with hub device 212 to transition between communication modes and output the associated superframes. That is, processors 240 may implement functionality and/or execute instructions associated with hub device 212 to output superframes in accordance with the mode that mode module 222 has currently set for hub device 212.

Examples of processors 240 include application processors, display controllers, auxiliary processors, one or more sensor hubs, and any other hardware configure to function as a processor, a processing unit, or a processing device. Modules 220 and 222 may be operable by processors 240 to perform various actions, operations, or functions of hub device 212. For example, processors 240 of hub device 212 may retrieve and execute instructions stored by storage components 248 that cause processors 240 to perform the operations described with respect to modules 220 and 222. The instructions, when executed by processors 240, may cause hub device 212 to transition between a premise communication mode and a community communication mode.

Communication module 220 may execute locally (e.g., at processors 240) to provide functions associated with communicating, using communication units 242, with various sensor devices and/or remote hub devices. In some examples, communication module 220 may act as an interface to a remote service accessible to hub device 212. For example, communication module 220 may be an interface or application programming interface (API) to a remote server that facilitates communication with the various sensor devices and/or remote hub devices.

In some examples, mode module 222 may execute locally (e.g., at processors 240) to provide functions associated with detecting events that cause hub device 212 to transition between modes. In some examples, mode module 222 may act as an interface to a remote service accessible to hub device 212. For example, mode module 222 may be an interface or application programming interface (API) to a remote server that detects whether hub device 212 should transition from a premise communication mode to a community communication mode.

One or more storage components 248 within hub device 212 may store information for processing during operation of hub device 212 (e.g., hub device 212 may store data accessed by modules 220 and 222 and rules data store 226 during execution at hub device 212). In some examples, storage component 248 is a temporary memory, meaning that a primary purpose of storage component 248 may not be long-term storage. Storage components 248 on hub device 212 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and rules data store 226. Storage components 248 may include a memory configured to store data or other information associated with modules 220 and 222 and rules data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of hub device 212 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers. Communication units 242 may also be configured to communicate using any number of wireless protocols, including time divisional multiple access (TDMA).

One or more input components 244 of hub device 212 may receive input. Examples of input are tactile, audio, and video input. Input components 244 of hub device 212, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252), including both internal sensors and connections to external sensors. Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, motion sensor, passive infrared (PIR) sensor, air temperature and/or humidity sensor, air quality (e.g., carbon monoxide or particulate matter) sensor, a door or window contact sensor, or a step counter sensor.

One or more output components 246 of hub device 212 may generate output in a selected modality. Examples of modalities may include a tactile notification, audible notification, visual notification, machine generated voice notification, or other modalities. Output components 246 of hub device 212, in one example, includes a presence-sensitive display, a sound card, a video graphics adapter card, a speaker, a cathode ray tube (CRT) monitor, a liquid crystal display (LCD), a light emitting diode (LED) display, an organic LED (OLED) display; a virtual/augmented/extended reality (VR/AR/XR) system, a three-dimensional display, or any other type of device for generating output to a human or machine in a selected modality:

UIC 210 of hub device 212 may include display component 202 and presence-sensitive input component 204. Display component 202 may be a screen, such as any of the displays or systems described with respect to output components 246, at which information (e.g., a visual indication) is displayed by UIC 210 while presence-sensitive input component 204 may detect an object at and/or near display component 202.

While illustrated as an internal component of hub device 212, UIC 210 may also represent an external component that shares a data path with hub device 212 for transmitting and/or receiving input and output. For instance, in one example, UIC 210 represents a built-in component of hub device 212 located within and physically connected to the external packaging of hub device 212 (e.g., a screen on a mobile phone). In another example, UIC 210 represents an external component of hub device 212 located outside and physically separated from the packaging or housing of hub device 212 (e.g., a monitor, a projector, etc. that shares a wired and/or wireless data path with hub device 212).

UIC 210 of hub device 212 may detect two-dimensional and/or three-dimensional gestures as input from a user of hub device 212. For instance, a sensor of UIC 210 may detect a user's movement (e.g., moving a hand, an arm, a pen, a stylus, a tactile object, etc.) within a threshold distance of the sensor of UIC 210. UIC 210 may determine a two or three-dimensional vector representation of the movement and correlate the vector representation to a gesture input (e.g., a hand-wave, a pinch, a clap, a pen stroke, etc.) that has multiple dimensions. In other words, UIC 210 can detect a multi-dimension gesture without requiring the user to gesture at or near a screen or surface at which UIC 210 outputs information for display. Instead, UIC 210 can detect a multi-dimensional gesture performed at or near a sensor which may or may not be located near the screen or surface at which UIC 210 outputs information for display.

In accordance with one or more techniques of this disclosure, mode module 222 may set hub device 212 to a premise communication mode. While hub device 212 is in the premise communication mode, communication module 220 may output, to a plurality of devices, a first superframe configured in a premise communication superframe mode. In the premise communication superframe mode, communication module 220 may allocate each slot of a plurality of slots for wireless communication to a first protocol at a first frequency band or a second protocol at the first frequency band, where the first protocol and the second protocol are different from each other.

At some point, mode module 222 may transition hub device 212 from the premise communication mode to a community communication mode. In some instances, permission may be required. In such instances, prior to transitioning hub device 212 from the premise communication mode to the community communication mode, mode module 222 may receive an indication of user input at input components 244 enabling the community communication mode on hub device 212.

In some examples, mode module 222 may be configured to transition the apparatus from the premise communication mode to the community communication mode in response to communication module 220 receiving a community communication mode command. Along with the community communication mode command, communication module 220 may also receive a dangerous event alarm notification with the community communication mode command. In other instances, the community communication mode command itself may be or include a dangerous event alarm notification. Mode module 222 may evaluate the dangerous event alarm notification to determine an alarm type. The alarm type could be any of a fire alarm, a carbon monoxide alarm, a panic alarm, a break-in alarm, or some other critical alarm (e.g., a flood alarm, a chemical alarm, or any other alarm that could affect premises other than the immediate premises where hub device 212 is located). Mode module 222 may determine, based at least in part on the alarm type, whether a nearby premises that houses the remote apparatus is in danger (e.g., some amount of property damage or personal damage could be imparted on the nearby premises due to the dangerous alarm event, or some amount of property damage or personal damage could be imparted on the premises that houses hub device 212). In response to determining that the nearby premises that houses the remote apparatus is in danger, transition the apparatus from the premise communication mode to the community communication mode.

In some instances, in determining whether the nearby premises that houses the remote apparatus is in danger, mode module 222 may use additional information, such as one or more settings of hub device 212, one or more characteristics of a premises that houses hub device 212, and one or more characteristics of the nearby premises that houses hub device 212. For example, if the alarm type is a flood alarm, and the premises that houses hub device 212 is a single-family home, then mode module 222 may determine that the nearby premises is not in danger and may not transition hub device 212 into community communication mode. Conversely, if the alarm type is a panic alarm, and settings of hub device 212 indicate that neighbors should be alerted when a panic alarm is detected at hub device 212 (e.g., the resident is elderly and requires assistance if there is a medical emergency), mode module 222 may determine that other homes should be alerted even though no damage is imminent to those homes.

While hub device 212 is in the community communication mode, communication module 220 may output, to the plurality of devices, a second superframe configured in a community communication superframe mode. In the community communication superframe mode, communication module 220 may allocate at least one slot of a plurality of slots for wireless communication to the first protocol at the first frequency band or the second protocol at the first frequency band. In community communication superframe mode, communication module 220 may also allocate at least one slot of the plurality of slots for wireless communication to a community beacon, the community beacon including data relating to a unique key recognizable by a remote apparatus.

In some instances, the community beacon is further configured to cause the remote apparatus to output an alarm indication when the remote apparatus receives the community beacon. The community beacon may also set off a chain of community beacons, where any remote apparatus that receives the community beacon may transition to community communication mode and output community communication superframes themselves. This chain may continue until no new device receives a community beacon for this particular event, creating a neighborhood of connected devices that notifies the entire neighborhood of potentially dangerous events.

If mode module 222 receives an indication of user input disabling the community communication mode on hub device 212, or if mode module 222 determines that the event is not dangerous to nearby premises, even if communication module 220 receives a second community communication mode command, communication module 220 may still output a third superframe configured in the premise communication superframe mode. In other words, in this instance, communication module 220 may refrain from outputting a superframe configured in the community communication superframe mode.

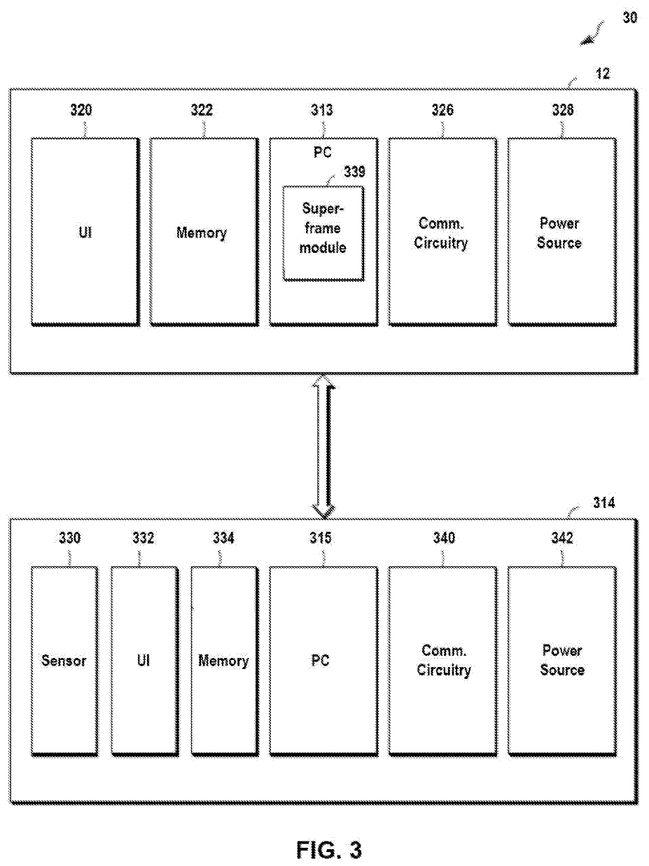

FIG. 3 is a conceptual block diagram of the hub device 12 and the sensor device 14, in accordance with some examples of this disclosure. System 30 may be an example of any of the previous systems 10, 20, or another system. System 30 includes hub device 12 and sensor device 14.

Hub device 12 may include at least a user interface (UI) 320, a memory 322, processing circuitry (PC) 313, communication circuitry 326 (“COMM. CIRCUITRY”), and a power source 328. UI 320 is configured to receive data input from, or output data to, a user. For example, UI 320 may include a display screen, such as a touchscreen, keyboard, buttons, microphone, speaker, camera, or any other user input/output device. Other examples of UI 320 are possible. For example, during an initial setup process, hub device 12 may “scan” a local proximity in order to identify one or more other devices (e.g., devices having recognizable wireless communication capabilities, such as an ability to communicate wirelessly at a second, different frequency band), and then output for display on a display screen a list of the discovered devices for selection by a user. Via UI 320, a user may also specify one or more parameters in order to control or otherwise manage a comfort and/or security system within a building and the surrounding premises. For example, via UI 320, a user may specify one or more air temperature settings or security settings, such as access codes and/or authorized users.

Hub device 12 includes a memory 322 configured to store data, as well as instructions that, when executed by processing circuitry 313, cause hub device 12 to perform one or more techniques in accordance with this disclosure. Communication circuitry 326 may include components, such as an antenna, configured to wirelessly transmit and receive data according to one or more wireless communication protocols. For example, communication circuitry 326 may be configured to transmit and/or receive data according to the IEEE 802.15.4 protocol, Wi-Fi™, and/or the BLUETOOTH protocol where appropriate, according to one or more constraints of the respective data communication protocols (e.g., communication range, energy requirements, etc.). As an additional example, communication circuitry 326 may be configured to transmit and/or receive data using each of a first frequency band and a second, different frequency band.

Power source 328 may include a wired connection to an electric power grid, due to the energy-intensive operations performed by hub device 12. However, in some examples, power source 328 may additionally or alternatively include an internal power source, such as a battery or supercapacitor. In the example of FIG. 3, hub device 12 omits a sensor, however, in some examples, hub device 12 may further include one or more sensors. Additionally, hub device 12 may be configured as a repeater node.

Sensor device 14 may be configured to wirelessly communicate with hub device 12. Sensor device 14 may include an incorporated sensor 330, a UI 332, a memory 334, processing circuitry (PC) 315, communication circuitry 340, and a power source 342. In some examples, sensor device 14 may include an incorporated sensor device, such as a motion sensor: passive infrared (PIR) sensor: air temperature and/or humidity sensor; air quality (e.g., carbon monoxide or particulate matter) sensor: or a door or window contact sensor, as non-limiting examples. Processing circuitry 313 may include wireless protocol selection module 339 that may be configured to select a first wireless protocol or a second wireless protocol for establishing a wireless connection. In some examples, wireless protocol selection module 339 may be configured to select between three or more wireless protocols for establishing a wireless connection. In addition or alternatively, processing circuitry 313 may include a frequency band selection module that may be configured to select first and second different frequency bands to be used for wireless communication.

UI 330 is configured to receive data input from, or output data to, a user. For example, UI 330 may include a display screen, such as a touchscreen, keyboard, buttons, microphone, speaker, camera, or any other user input/output device. Other examples of UI 330 are possible. For example, during an initial setup process, sensor device 14 may “scan” a local proximity in order to identify one or more hub devices and/or other devices (e.g., devices having recognizable wireless communication capabilities), and then output for display on a display screen a list of discovered devices for selection by a user. Via UI 330, a user may also specify one or more parameters in order to control or otherwise manage a comfort and/or security system within a building and the surrounding premises. For example, via UI 330, a user may specify one or more air temperature settings (e.g., for a thermostat) or security settings, such as access codes and/or authorized users. Sensor device 14 includes a memory 334 configured to store data, as well as instructions that, when executed by processing circuitry 315, cause sensor device 14 to perform one or more techniques in accordance with this disclosure.

Processing circuitry 315 and hub device 12 may exchange network parameters for pairing a BLUETOOTH channel. For example, processing circuitry 315 may determine (e.g., receive from hub device 12 or generate for output to hub device 12), one or more of: (1) a media access control (MAC) address of host device 22 and a MAC address of thermostat 24A; (2) a real time-point in time for the transfer to start (or offset from 802.15.4 start command); (3) an indication of a starting frequency; (4) an indication of a hop set; (5) a connection interval; or (6) a connection latency.

For example, processing circuitry 315 and hub device 12 may exchange a MAC address for device 12 and a MAC address for sensor device 14. In this example, communication circuitry 326 and communication circuitry 340 may be configured to establish a BLUETOOTH channel between the MAC address for hub device 12 and the MAC address for sensor device 14.

In some examples, processing circuitry 315 and hub device 12 may exchange an indication of a particular time to establish the BLUETOOTH channel. In this example, communication circuitry 326 and communication circuitry 340 may be configured to establish the BLUETOOTH channel between hub device 12 and sensor device 14 at the particular time.

For example, processing circuitry 315 and hub device 12 may exchange an indication of a starting frequency to establish the BLUETOOTH channel. In this example, communication circuitry 326 and communication circuitry 340 may be configured to establish a BLUETOOTH channel between hub device 12 and sensor device 14 at the starting frequency. For instance, the BLUETOOTH channel between hub device 12 and sensor device 14 may include 40 1 MHz wide channels that are separated by 21 MHz. In this example, the starting frequency may be an indication of a particular 1 MHz wide channel (e.g., channel 0, 1, . . . 39) and communication circuitry 326 and communication circuitry 340 may be configured to establish a BLUETOOTH channel between hub device 12 and sensor device 14 at the particular 1 MHz wide channel. The various frequencies of BLUETOOTH channels of BLUETOOTH channels, while slightly different from each other, may all correspond to a frequency for a superframe (e.g., 2.4 GHz). The processing circuitry 315 and hub device 12 may exchange an indication of a particular frequency band (e.g., the first frequency band or the second, different frequency band) to be used for wireless communications therebetween.

Processing circuitry 315 and hub device 12 may exchange an indication of a hop set for the BLUETOOTH channel, the hop set indicating a sequence of frequencies. In this example, communication circuitry 326 and communication circuitry 340 may be configured to establish a BLUETOOTH channel between hub device 12 and sensor device 14 to operate at the sequence of frequencies. For instance, the BLUETOOTH channel between hub device 12 and sensor device 14 may include 40 1 MHz wide channels that are separated by 2 MHz. In this example, the sequence of frequencies may be an indication of an order for switching between the 1 MHz wide channels (e.g., channel 0, 1, . . . 39) and communication circuitry 326 and communication circuitry 340 may be configured to establish a BLUETOOTH channel between hub device 12 and sensor device 14 that selects a 1 MHz wide channel according to the order for switching between the 1 MHz wide channels.

In some examples, processing circuitry 315 and hub device 12 may exchange an indication of a connection interval for the BLUETOOTH channel. In this example, communication circuitry 326 and communication circuitry 340 may be configured to establish a BLUETOOTH channel between hub device 12 and sensor device 14 to operate at the connection interval. For instance, rather than exchanging data at any time on the BLUETOOTH channel between hub device 12 and sensor device 14, the BLUETOOTH channel between hub device 12 and sensor device 14 may be configured to initiate a transfer of data on BLUETOOTH channel between hub device 12 and sensor device 14 at the connection interval.

Processing circuitry 315 and hub device 12 may exchange an indication of a connection latency for the BLUETOOTH channel. In this example, communication circuitry 326 and communication circuitry 340 may be configured to establish a BLUETOOTH channel between hub device 12 and sensor device 14 to operate at the connection latency. For instance, rather than exchanging data at any time or at a connection interval on the BLUETOOTH channel between hub device 12 and sensor device 14, the BLUETOOTH channel between hub device 12 and sensor device 14 may be configured to initiate a transfer of data on BLUETOOTH channel between hub device 12 and sensor device 14 at a latency interval of sensor device 14 or hub device 12. This latency interval may be selected to reduce a time a radio of sensor device 14 and/or hub device 12 listens for data (further from a connection interval), which may reduce a power consumption of sensor device 14 and/or hub device 12 compared to systems that omit a latency interval or use a zero latency interval.

Processing circuitry 315 and hub device 12 may exchange an indication of antenna information for a plurality of antennas at sensor device 314. In this example, communication circuitry 326 and communication circuitry 340 may be configured to select a particular antenna from the plurality of antennas based on the antenna information and to establish a BLUETOOTH channel between hub device 12 and sensor device 14 using the particular antenna.

Hub device 12 and sensor device 14 may be configured to operate using a superframe. For example, hub device 12 may be configured to operate in a premise communication mode. While hub device 12 is in the premise communication mode, superframe module 339 may output, sensor device 314, a first superframe configured in a premise communication superframe mode. In the premise communication superframe mode, superframe 339 allocates each slot of a plurality of slots for wireless communication to a first protocol at a first frequency band or a second protocol at the first frequency band, wherein the first protocol and the second protocol are different from each other. Processing circuitry 313 may then transition the apparatus from the premise communication mode to a community communication mode. While hub device 12 is in the community communication mode, superframe module 339 may output, to sensor device 314, a second superframe configured in a community communication superframe mode. In the community communication superframe mode, superframe module 339 allocates at least one slot of a plurality of slots for wireless communication to the first protocol at the first frequency band or the second protocol at the first frequency band, and further allocates at least one slot of the plurality of slots for wireless communication to a community beacon, the community beacon including data relating to a unique key recognizable by a remote apparatus. The data relating to the unique key can correspond to data received at the remote apparatus (e.g., from a remote server or from the hub device 12) at a time prior to that remote apparatus receiving the community beacon including data relating to the unique key.

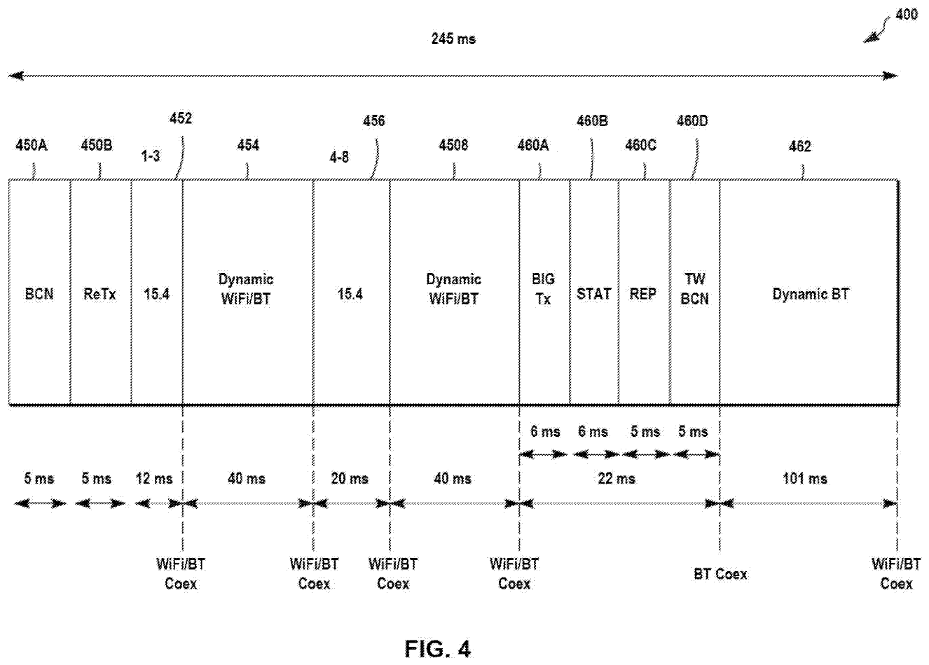

FIG. 4 is a conceptual block diagram of a first example of slots for a first superframe, for instance configured in an initial superframe mode, in accordance with some examples of this disclosure. Thus, the first superframe 400 can be one example of a first superframe configured in an initial superframe mode. The first superframe 400, configured in the initial superframe mode, can include the slots as allocated to communications using a first frequency band (e.g., first superframe 400 in the initial superframe mode may include only slots allocated to communications using the first frequency band). As shown, the first superframe 400 may include a beacon slot 450A (“BCN 450A”) and a retransmission slot 450B (“ReTx”), which may be collectively referred to here as beacon slot A 450. The order of slots shown in FIG. 4 is for example purposes only. Timing shown in FIG. 4 is for example purposes only. For example, the first superframe 400 may be shorter than 245 ms or longer than 245 ms. The first superframe 400 is for example purposes only. For example, a superframe may include different slots (e.g., one or more slots may be removed and/or one or more slots may be added) and/or may include slots of different widths (e.g., different durations) than superframe 400.

Beacon slot 450A may mark the beginning of superframe 400. Beacon slot 450A may be used by all the end devices (e.g., sensor devices 14) to synchronize to the coordinator (e.g., hub device 12). As such, all devices in the system may synchronize to a master clock of the coordinator (e.g., hub device 12) thus forming a time synchronized networking system. Beacon slot 450A may include information that is used by the end devices to understand the system status, respond to commands, or other information, such as a frequency band at which a device (e.g., sensor device 14) will be communicating. The duration of beacon slot 450A may be 5 ms. The order of beacon slot 450A and a retransmission slot 450B shown in FIG. 4 is for example purposes only. Beacon slot A 450 may include additional or fewer slots. In some examples, the timing of beacon slot 450A may be less than 5 ms or more than 5 ms.

Retransmission slot 450B may be used for a new (e.g., non-enrolled) devices to associate with a coordinator (e.g., hub device 12) and thus become part of a personal area network (PAN), such as system 10, system 20, system 30 or another system. Once the enrollment mode is disabled, end devices of the previous superframe group may use retransmission 450B to attempt retransmission. The duration of retransmission slot 450B may be 5 ms.

15.4 slots 452 and 456 may be used for communications compliant with IEEE 802.15.4. In an example, there may be up to 2 or 4 15.4 slots in a superframe, however, other examples may use other combinations. Each slot may include sub-slots comprising a duration of, for example, 2 ms, 4 ms, 5, ms, etc. End devices (e.g., sensor devices 14) may use 15.4 slots 452 and 456 to transmit an alarm message, a status message, a Redlink™ network protocol (RNP) message, a supervision message, or other information. The total duration of each of 15.4 slot 452 and 15.4 slot 456 time segment may be, for example, 32 ms or 64 ms. The media access protocol for 15.4 slots 452 and 456 used may be TDMA. If a sensor device is not enrolled in a 15.4 slot, hub device 12 may allocated the 15.4 slots to Wi-Fi™ or BLUETOOTH.

Dynamic Wi-Fi™ BLUETOOTH slot 454 (“DYNAMIC Wi-Fi™/BT 454”) and dynamic Wi-Fi™ BLUETOOTH slot 458 (“DYNAMIC Wi-Fi™/BT 458”) may be referred to herein as a Wi-Fi™ coexistence time segments. A Wi-Fi™ time segment may be used by a Wi-Fi™ module populated on a thermostat device to transmit different types of network packets. Dynamic Wi-Fi™ BLUETOOTH slot 454, 458 may include alarm messages from the thermostat device to the central monitoring station, video streaming packets from one Wi-Fi™ client (e.g., camera or video capable sensor video/image) to another (e.g., GUI based touch screen/Cloud, etc.). The Wi-Fi™ might be operating in different modes: (a) Wi-Fi™ Client, (b) Wi-Fi™-AP. (c) Wi-Fi™-Hybrid. Wi-Fi™ slots may be dynamic, these slots may be shared to BLUETOOTH or Wi-Fi™ depending on different modes of superframes. As shown, dynamic Wi-Fi™ BLUETOOTH slot 454 and dynamic Wi-Fi™ BLUETOOTH slot 458 may be 40 ms.

Big TX/RX Slot 460A (“Big Tx 460A”), status slot 460B, repeater slot 460C (“REP 460C”), and twin beacon slot 460D (“TW BCN 460D”) may be collectively referred to herein as beacon slot B 460. The order of Big TX/RX Slot 460A, status slot 460B, repeater slot 460C, and twin beacon slot 460D shown in FIG. 4 is for example purposes only. Beacon slot B 460 may include additional or fewer slots.

Big TX/RX Slot 460A may include one or more large data transmit slots that are each more than 10 bytes and may be up to 96 bytes. An access point (e.g., hub device 12) may be able to send any data to any device using this slot. Data can be unicast, broadcast or groupcast depending on a type of request. This mode of communication may be indicated in beacon A slot 450. Big TX/RX Slot 460A may be used to send over-network download (OND) blocks to sensor devices or to set configure sensor devices. If the TX/RX Slot 460A is not active, hub device 12 may allocate time for TX/RX Slot 460A to Wi-Fi™ to increase time for Wi-Fi™ communication.

Status slot 450B may share a status with some or all of sensor devices 14. Status slot 450B may not be active at every instance of a superframe. Status slot 450B may include data that is unicast, broadcast, or groupcast depending on a type of request. This mode of communication may be indicated in beacon A slot 450.

Repeater slot 460C may be configured for sending and receiving data from repeaters of a large/small data. An access point (e.g., hub device 12) may be able to send any data to any repeater using repeater slot 460C. Data included in repeater slot 460C can be unicast, broadcast or groupcast depending on a type of request. This mode of communication may be indicated in beacon A slot 450.

Twin beacon slot 460D may be called information beacon/twin beacon. Payload of twin beacon 460D may be almost same as beacon slot 450A with some exceptions but may operate in a different channel referred to herein as an information channel. Twin beacon slot 460D may be present in all superframes irrespective of modes of operation. Twin beacon slot 460D may be used by all the end devices to synchronize to the coordinator only if they lose connection with an access point using beacon slot 450A. Twin beacon slot 460D may not be used for synchronization of time but may be used to share the information like what is the operation channel or frequency hopping sequence or a next channel of communication. The duration of twin beacon slot 460D may be 5 ms. In some examples, the timing of twin beacon slot 460D may be less than 5 ms or more than 5 ms.

Dynamic BLUETOOTH slot 462 may be dedicated to BLUETOOTH by an access Point (e.g., hub device 12). Dynamic BLUETOOTH slot 462 may support mobile and sensor communication. Allocation of dynamic BLUETOOTH slot 462 may vary with different modes of comfort/security superframes as described further below. As shown, dynamic BLUETOOTH slot 462 may be 101 ms. In some examples, the timing of dynamic BLUETOOTH slot 462 may be less than 101 ms or more than 101 ms.

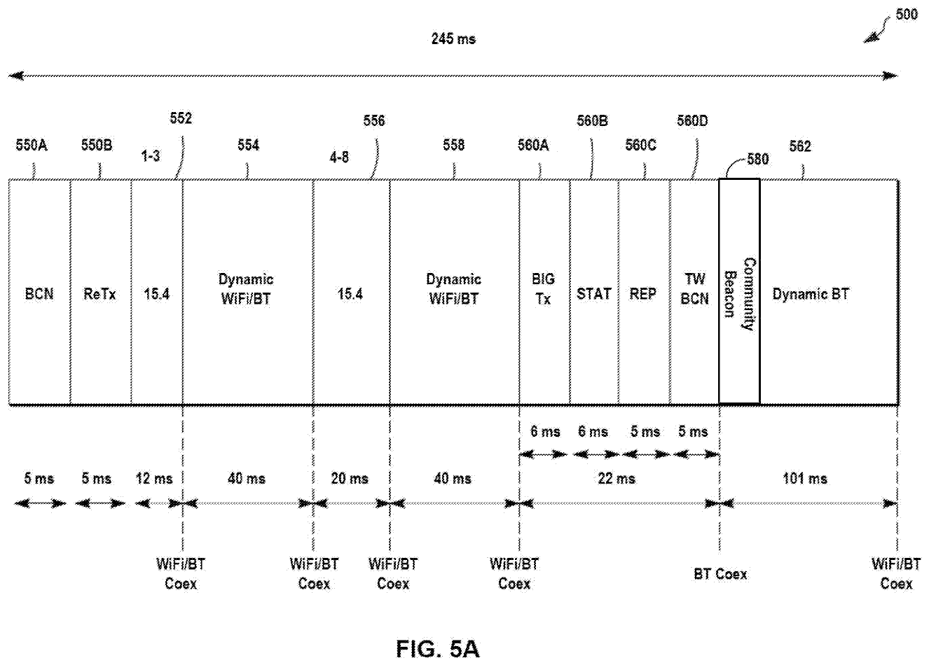

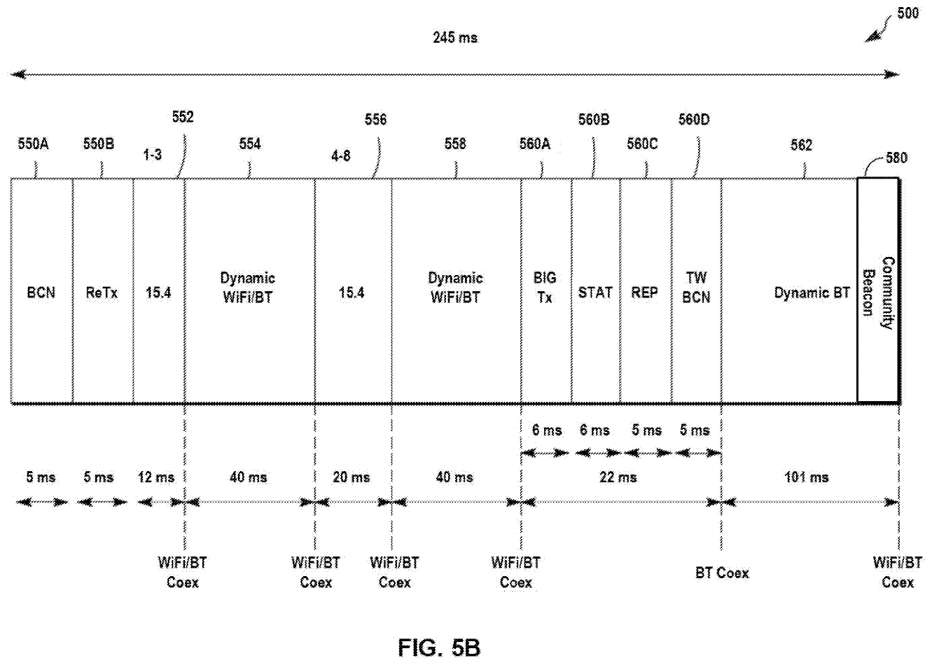

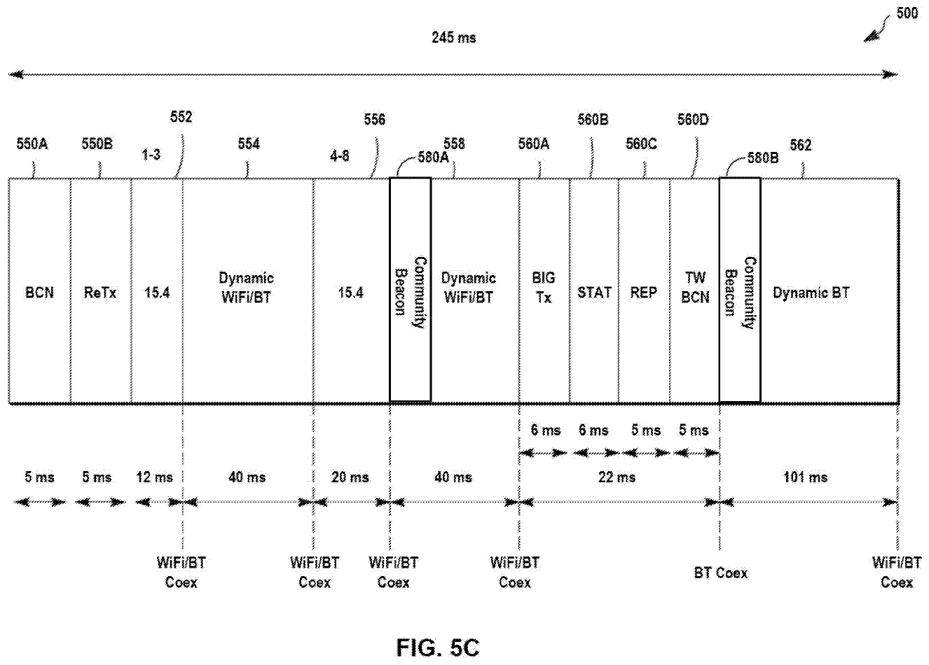

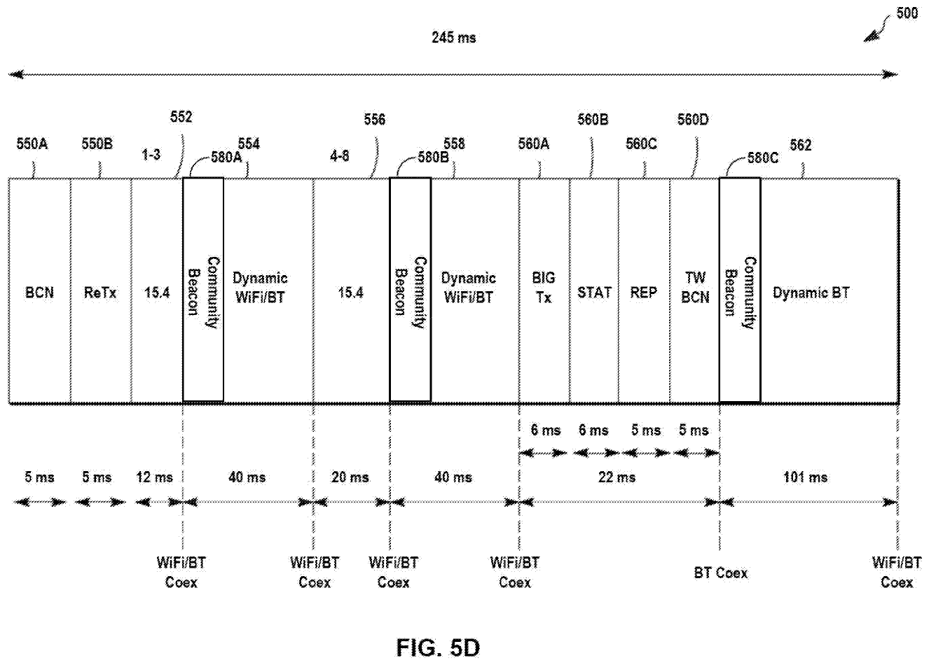

FIGS. 5A-5D illustrate examples of a superframe configured in a community communication superframe mode. As shown in the embodiments of FIGS. 5A-5D, a single superframe can be configured in a community communication superframe mode such that the single superframe has at least one slot, of a plurality of slots for wireless communication, allocated to a community beacon 580. Community beacon 580 includes data relating to a unique key recognizable by a remote apparatus. Community beacon 580 enables hub device 12 to transmit alarm events to nearby premises and remote hub devices such that the remote hub devices receive indications of the alarm events. The remote hub devices can then output the corresponding alarms to residents of their premises, as certain events, such as fires, could spread beyond the immediate premises at which the events are detected.

As shown in FIGS. 5A-5D, community beacon 580 may be at any number of locations in superframe 500. FIG. 5A shows community beacon 580 located at the beginning of dynamic BLUETOOTH slot 562. FIG. 5B shows community beacon 580 located at the end of dynamic BLUETOOTH slot 562.

In some instances, multiple instances of community beacon 580 may be inserted into superframe 500. For example, in FIG. 5C, community beacon 580A is located in the beginning of dynamic WiFi/BLUETOOTH slot 558, while community beacon 580B is located in the beginning of dynamic BLUETOOTH slot 562. In FIG. 5D, the hub device inserts three instances of community beacon 580. Community beacon 580A is located in the beginning of dynamic WiFi/BLUETOOTH slot 554, community beacon 580B is located in the beginning of dynamic WiFi/BLUETOOTH slot 558, and community beacon 580C is located in the beginning of dynamic BLUETOOTH slot 562. In other examples, the hub device may insert even more instances of community beacon 580 in superframe 500, or may insert instances of community beacon 580 in other locations within superframe 500.

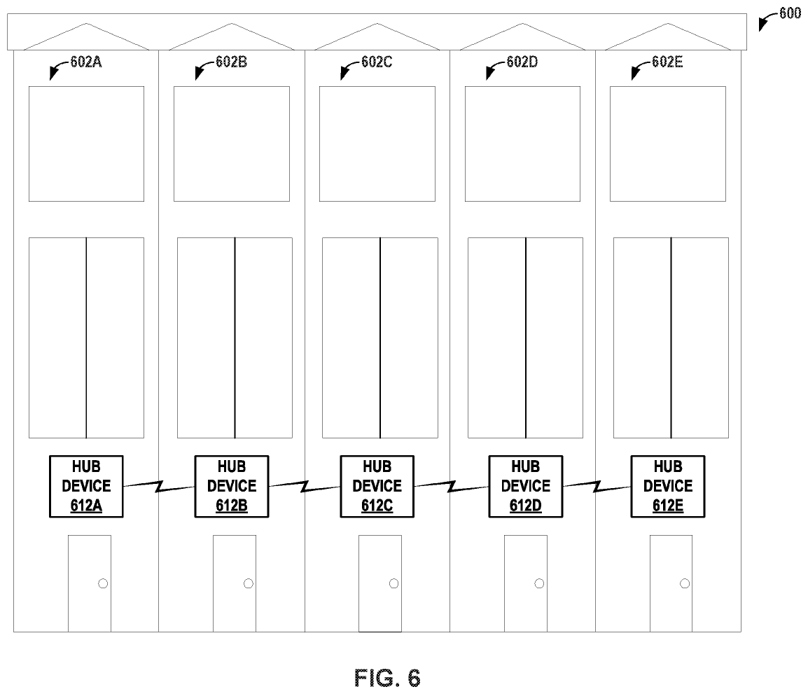

FIG. 6 is a conceptual diagram of a multiplex dwelling 600 that includes multiple different homes 602A-602E in a same overall building, in accordance with some examples of this disclosure. In the example of FIG. 6, each of homes 602A-602E includes a respective hub device 612A-612E to control any number of sensors located in the respective homes 602A-602E.

Each of hub devices 612A-612E may be initially set to operate in premise communication mode, such that superframes output by each of hub devices 612A-612E are only evaluated locally by the sensor devices in the respective homes 602A-602E. A sensor in home 602B may detect that a fire has started in home 602B. As such, the sensor may transmit the alarm event to hub device 612B. The sensor may also communicate a community communication mode command, or hub device 612B may generate the community communication mode command in response to receiving the alarm event. In either case, hub device 612B may output an alarm and transition from the premise communication mode to a community communication mode. Hub device 612B may then output a new superframe in community communication superframe mode, as the fire in home 602B may affect the surrounding, connected homes 602A and 602C-602E.

When hub device 612B broadcasts the community superframe, additional ones of hub devices 612A and 612C-612E may receive the community superframe (depending on the range). For instance, if the range of the community superframe enables all hub devices within two homes of hub device 612B to receive the community superframe, then hub devices 612A, 612C, and 612D may each receive the community superframe. Each of hub devices 612A, 612C, and 612D may then output an alarm condition within the respective homes 602A, 602C, and 602D such that the residents of those homes are aware that there is a fire within building 600.

In some instances, one or more of hub devices 612A, 612C, and 612D may continue the broadcasting chain to alert additional users, creating a mesh network of hub devices and alarm signals. For instance, in response to receiving the community superframe from hub device 612B, hub device 612D may transition itself from premise communication mode to community communication mode. While hub device 612D is in the community communication mode, hub device 612D may itself output a superframe configured in the community communication superframe mode. As the superframe is configured in the community communication superframe mode, additional hub devices in range of hub device 612D, such as hub device 612E, may now receive an indication of the alarm event at hub device 612B.

In this way, a fire in home 602B, which could affect all of homes 602A-602E within building 600, as well as any surrounding buildings, triggers alarms from each of hub devices 612A-612E in each of homes 602A-602E without sending additional superframes to clutter a network that may be needed to contact emergency services.

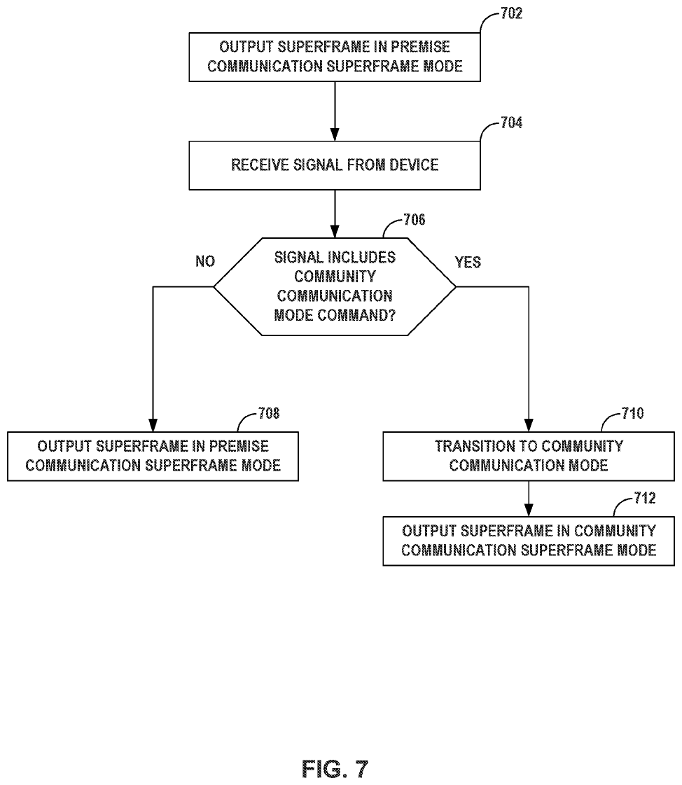

FIG. 7 is a flow chart illustrating an example mode of operation. The techniques of FIG. 7 may be performed by one or more processors of a computing device, such as hub device 12 of FIG. 1 and/or hub device 212 illustrated in FIG. 2B. For purposes of illustration only, the techniques of FIG. 7 are described within the context of hub device 12 of FIG. 1, although computing devices having configurations different than that of hub device 12 may perform the techniques of FIG. 7.

In step 702, processing circuitry 15 of hub device 12 outputs a first superframe configured in a premise communication superframe mode. The premise communication superframe mode allocates each slot of a plurality of slots for wireless communication to a first protocol at a first frequency band or a second protocol at the first frequency band, where the first protocol and the second protocol are different from each other.

In step 704, processing circuitry 15 receives a signal from a device.

In step 706, processing circuitry 15 evaluates the signal to determine whether the signal includes a community communication mode command. If the signal does not include a community communication mode command (“NO” branch of 706), processing circuitry 15 proceeds to step 708, where the processing circuitry outputs a second superframe configured in the premise communication superframe mode.

Conversely, if the signal does include a community communication mode command (“YES” branch of 706), processing circuitry 15 proceeds to step 710, where processing circuitry 15 transitions hub device 12 from the premise communication mode to a community communication mode. In step 712, processing circuitry 712 outputs a second superframe configured in a community communication superframe mode. The community communication superframe mode allocates at least one slot of a plurality of slots for wireless communication to the first protocol at the first frequency band or the second protocol at the first frequency band. The community communication superframe mode also allocates at least one slot of the plurality of slots for wireless communication to a community beacon, the community beacon including data relating to a unique key recognizable by a remote apparatus.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry: Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. An apparatus for communication with a plurality of devices, the apparatus comprising processing circuitry configured to:
set the apparatus to a premise communication mode;
while the apparatus is in the premise communication mode, output, to the plurality of devices, a first superframe configured in a premise communication superframe mode, the premise communication superframe mode allocating each slot of a plurality of slots for wireless communication to a first protocol at a first frequency band or a second protocol at the first frequency band, wherein the first protocol and the second protocol are different from each other;
transition the apparatus from the premise communication mode to a community communication mode; and
while the apparatus is in the community communication mode, output, to the plurality of devices, a second superframe configured in a community communication superframe mode, the community communication superframe mode allocating: i) at least one slot of a plurality of slots for wireless communication to the first protocol at the first frequency band or the second protocol at the first frequency band, and ii) at least one slot of the plurality of slots for wireless communication to a community beacon, the community beacon including data relating to a unique key recognizable by a remote apparatus.

2. The apparatus of claim 1, wherein the processing circuitry is configured to transition the apparatus from the premise communication mode to the community communication mode in response to the processing circuitry receiving a community communication mode command.

3. The apparatus of claim 2, wherein the processing circuitry is further configured to receive a dangerous event alarm notification with the community communication mode command.

4. The apparatus of claim 2, wherein the community communication mode command comprises a dangerous event alarm notification, wherein the processing circuitry is further configured to:
evaluate the dangerous event alarm notification to determine an alarm type;
determine, based at least in part on the alarm type, whether a nearby premises that houses the remote apparatus is in danger; and
in response to determining that the nearby premises that houses the remote apparatus is in danger, transition the apparatus from the premise communication mode to the community communication mode.

5. The apparatus of claim 4, wherein the processing circuitry is further configured to determine whether to transition the apparatus from the premise communication mode to the community communication mode based on one or more of:
one or more settings of the apparatus,
one or more characteristics of a premises that houses the apparatus, and
one or more characteristics of the nearby premises that houses the remote apparatus.

6. The apparatus of claim 2, wherein the dangerous event alarm notification comprises one or more of a fire alarm notification, a carbon monoxide alarm notification, a panic alarm notification, a break-in alarm notification, or a critical alarm notification.

7. The apparatus of claim 1, wherein the community beacon is configured to cause the remote apparatus to output an alarm indication when the remote apparatus receives the community beacon.

8. The apparatus of claim 1, wherein the apparatus is configured for communication with the plurality of devices using time divisional multiple access (TDMA).

9. The apparatus of claim 1, wherein the processing circuitry is further configured to:
prior to transitioning the apparatus from the premise communication mode to the community communication mode, receive an indication of user input enabling the community communication mode on the apparatus.

10. The apparatus of claim 9, wherein the processing circuitry is further configured to:
receive an indication of user input disabling the community communication mode on the apparatus;
receive a second community communication mode command;
output a third superframe configured in the premise communication superframe mode; and
refrain from outputting a fourth superframe configured in the community communication superframe mode.

11. A method comprising:
setting, by one or more processors of an apparatus for communication with a plurality of devices, the apparatus to a premise communication mode;
while the apparatus is in the premise communication mode, outputting, by the one or more processors, and to the plurality of devices, a first superframe configured in a premise communication superframe mode, the premise communication superframe mode allocating each slot of a plurality of slots for wireless communication to a first protocol at a first frequency band or a second protocol at the first frequency band, wherein the first protocol and the second protocol are different from each other;
transitioning, by the one or more processors, the apparatus from the premise communication mode to a community communication mode; and
while the apparatus is in the community communication superframe mode, outputting, by the one or more processors, and to the plurality of devices, a second superframe configured in a community communication superframe mode, the community communication superframe mode allocating: i) at least one slot of a plurality of slots for wireless communication to the first protocol at the first frequency band or the second protocol at the first frequency band, and ii) at least one slot of the plurality of slots for wireless communication to a community beacon, the community beacon including data relating to a unique key recognizable by a remote apparatus.

12. The method of claim 11, wherein transitioning the apparatus from the premise communication mode to the community communication mode comprises transitioning, by the one or more processors, the apparatus from the premise communication mode to the community communication mode in response to the processing circuitry receiving a community communication mode command.

13. The method of claim 12, wherein the method further comprises:
receiving, by the one or more processors, a dangerous event alarm notification with the community communication mode command.

14. The method of claim 12, wherein the community communication mode command comprises a dangerous event alarm notification, wherein the method further comprises:
evaluating, by the one or more processors, the dangerous event alarm notification to determine an alarm type;
determining, by the one or more processors, based at least in part on the alarm type, whether a nearby premises that houses the remote apparatus is in danger; and
in response to determining that the nearby premises that houses the remote apparatus is in danger, transitioning, by the one or more processors, the apparatus from the premise communication mode to the community communication mode.

15. The method of claim 14, wherein the method further comprises determining, by the one or more processors, whether to transition the apparatus from the premise communication mode to the community communication mode based on one or more of:
one or more settings of the apparatus,
one or more characteristics of a premises that houses the apparatus, and
one or more characteristics of the nearby premises that houses the remote apparatus.

16. The method of claim 12, wherein the dangerous event alarm notification comprises one or more of a fire alarm notification, a carbon monoxide alarm notification, a panic alarm notification, a break-in alarm notification, or a critical alarm notification.

17. The method of claim 11, wherein the method further comprises:
in response to the remote apparatus receiving the alarm indication, outputting, by one or more processors of the remote apparatus, an alarm indication.

18. The method of claim 11, wherein the apparatus is configured for communication with the plurality of devices using time divisional multiple access (TDMA).

19. The method of claim 11, wherein the method further comprises:
prior to transitioning the apparatus from the premise communication mode to the community communication mode, receiving, by the one or more processors, an indication of first user input enabling the community communication mode on the apparatus;
receiving, by the one or more processors, an indication of second user input disabling the community communication mode on the apparatus;
receiving, by the one or more processors, a second community communication mode command;
outputting, by the one or more processors, a third superframe configured in the premise communication superframe mode; and
refraining, by the one or more processors, from outputting a fourth superframe configured in the community communication superframe mode.

20. A system comprising:
a hub device comprising a first set of one or more processors;
a plurality of devices in communication with the hub device; and
a remote hub device comprising a second set of one or more processors,
wherein the first set of one or more processors of the hub device are configured to:
set the hub device to a premise communication mode;
while the hub device is in the premise communication mode, output, to the plurality of devices, a first superframe configured in a premise communication superframe mode, the premise communication superframe mode allocating each slot of a plurality of slots for wireless communication to a first protocol at a first frequency band or a second protocol at the first frequency band, wherein the first protocol and the second protocol are different from each other;
transition the hub device from the premise communication mode to a community communication mode; and
while the hub device is in the community communication mode, output, to the plurality of devices, a second superframe configured in a community communication superframe mode, the community communication superframe mode allocating: i) at least one slot of a plurality of slots for wireless communication to the first protocol at the first frequency band or the second protocol at the first frequency band, and ii) at least one slot of the plurality of slots for wireless communication to a community beacon, the community beacon including data relating to a unique key recognizable by a remote hub device, and
wherein the second set of one or more processors of the remote hub device are configured to:
in response to receiving the community beacon, output an alarm condition;
transition the remote hub device from the premise communication mode to the community superframe mode; and
while the remote hub device is in the community communication mode, output a third superframe configured in the community communication superframe mode.
